(19) United States
(12) Patent Application Publication
(10) Pub. No.: US 2004/0068470 A1
(43) Pub. Date: Apr. 8, 2004

(54) Distributing public keys

(76) Inventor: Graham Klyne, Reading (GB)

Correspondence Address: Brett C Martin, Shaw Pittman, 1650 Tysons Boulevard, McLean, VA, 22102, US

(21) Appl. No.: 10/415,402

(22) PCT Filed: Oct. 31, 2001
(86) PCT No.: PCT/GB01/04827

(30) Foreign Application Priority Data
Nov. 1, 2000 (GB) 0026688.2

(51) Int. Cl. G06F 17/60; H04L 9/00; H04K 1/00

(52) U.S. Cl. 705/50; 380/279

(57) ABSTRACT

A secure method and system for distributing and verifying encryption and decryption keys as used in any public key encryption scheme to provide authenticity and confidentiality. The public key is encoded in accordance with a 2-D barcode symbology and printed onto a mass produced item for distribution. A value critical amount, such as the value on a purchase receipt, may be encoded together with the public key. The public key is obtained by taking an image of the encoded 2-D barcode and decoding the image into a public key and value critical amount, if any. The public key is extracted and may be stored in an Internet web browser facility by a customer for use in a second on-line transaction. The value critical amount may be displayed on screen to enable a verification to be carried out by the customer that the public key has been correctly generated.

### TECHNICAL FIELD OF THE INVENTION

This invention relates to a security system, and particularly, although not exclusively, to a secure system and method for distributing and verifying encryption and decryption keys as used in any public-key encryption scheme to provide confidentiality and authenticity.

### BACKGROUND TO THE INVENTION

Public-key cryptography is a system which enables users which have never met to secure transmitted messages against unauthorized reading through use of a pair of linked encryption keys, and to add digital signatures to messages to guarantee their authenticity. One public-key cryptography system is Pretty Good Privacy™ (PGP™), originally developed by Philip Zimmermann, which is commonly used for encrypting data sent across the Internet, and in file-storage applications. PGP is based on algorithms that have survived extensive public review and are considered extremely secure (Rivest, Shamir and Adleman (RSA) for public-key encryption, International Data Exchange Algorithm (IDEA) for conventional encryption, and Message Digest 5 (MD5) for hash, or summary coding.

Public-key encryption has a wide range of applicability and can be used by individuals who wish to communicate securely with people worldwide over the Internet and other networks, commercial organisations wishing to conduct secure transactions with customers across the internet, and by corporations that want to enforce a standardized scheme for encrypting files and messages.

An inherent problem for a user of PGP, or any public-key application, is obtaining the public encryption keys of the parties with which the user wishes to correspond in a secure manner. For instance, an impostor may create a linked pair of public and private keys and distribute the public key, declaring himself to be some other trustworthy party. The impostor could send messages signed using the private key, and the recipient, using the corresponding public key, would believe they originated from the trustworthy party. Furthermore, if the individual sent a message to the trustworthy party encrypted using what the individual trusted to be the public key, the impostor could capture the message and recover the plain text using his private key. This problem is known as the Public Key Infrastructure (PKI) problem.

A number of tools and recommended procedures are currently provided for verifying public keys. One such tool is the public-key fingerprint, which is a short string of printable characters obtained from applying a message digest algorithm (such as MD5 or SHA-1) to the public key (and a small amount of additional data) to produce a summary code of the key. Such a summary code comprises a characteristic numerical representation of the public key which is much shorter in length than the public key (for example MD5 produces a 128-bit summary code). The summary code can therefore be used as a layer of security for authenticating a public key sent via email or other means as it is virtually unique. However a secure channel is still needed for communicating the summary code (e.g. telephone) for verification purposes.

Alternatively, a first party (or Certification Authority) known to and trusted by a user can provide the user with the public keys of second parties if they are known and trusted by the first party, by signing these keys with his own private key. The user can then extract the second party public keys by decrypting with the public key of the trusted first party. In practice, there are multiple Certification Authorities. Moreover, the “second parties” described above can also act as Certification Authorities in their own right.

Thus, this method is limited to cases where two users trust a common Certification Authority, either directly or indirectly. Further, there is a difficulty in distributing and obtaining trustworthy public key material. If any key is compromised, the damage can be widespread.

Therefore, there exists a need for a method of distributing public keys in a manner which is convenient to the end user yet remains secure.

### STATEMENT OF THE INVENTION

According to a first aspect of the invention, there is provided a method for distributing a public key, comprising: a) receiving a data stream containing a public key; b) extracting said public key from said data stream; c) encoding said public key in accordance with a predetermined graphical code; d) printing said encoded public key onto a mass produced item in machine readable form.

Such a method allows a public key to be distributed between an issuing organisation such as a retailer and a client or customer, in a manner which retains a physical link, in the form of the printed material, between the issuing organization and the customer. The mass distribution of the public key in a physical form therefore makes it more difficult to compromise the integrity of the public key.

The public key is typically published in paper form, as such a format is cheap to distribute. For instance, such public keys could be published in national daily newspapers, magazines, literature distributed from company branches, directory listings such as Yellow Pages™, printed on cheques or account statements, or purchase receipts issued by retail premises. Given such means of mass distribution, a fraudster would have to subvert each of these individually in order to substitute an undetectable false public key.

To ensure the public key may be represented efficiently within a given area, the machine readable form used is preferably a 2-D barcode symbology. Such a representation maintains a very high data security rate and permits near real-time data capture rates in comparison with other automatic methods of data representation and entry.

According to a second aspect of the present invention, there is provided a method for supplying a public key from a distributor to a recipient, the method comprising: a) receiving a data stream from a computer, the data stream containing the public key; b) receiving transaction-specific data known to the distributor and receiver; c) extracting said public key from said data stream; d) encoding said public key and said transaction-specific data in accordance with a predetermined graphical code; e) printing said encoded data in machine readable form; and f) supplying the printed item to the receiver.

The transaction-specific data may be generated at the time of the supply of the printed item, and may for example be a password, a customer account number, or a value of a transaction. The transaction-specific data is encoded together with the public key at the time of generating the machine readable form, and is decoded in the validation process. It forms an added layer of security, allowing a check to be carried out by the customer and hence makes it harder to substitute a false key that cannot be detected by the customer.

For example, if the total value of the purchase was printed both on the purchase receipt and separately incorporated into the encoded symbol, the customer would be able to verify that the symbol containing the public key had been correctly generated.

With the system of the present invention a significantly increased level of security is provided. As well as comprising information known to the consumer and retailer, the encoded image is preferably generated at the time of a retail or other transaction at which the customer is physically present. This provides a physical link between the customer and the provider of the public key material.

In accordance with further aspects of the present invention, there are provided a software product and a computer system which contain code for implementing any of the other aspects.

Preferably, the software may include code for interfacing with Internet web browser software. Conventionally known in the art as a “plug-in” to the web browser, this facilitates the process for the customer by automating the steps of the process. The software is preferably activated automatically on connection to a trader's secure server facility, and would use information obtained from the graphical representation as part of the process of authenticationg the trader's facility.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is schematic diagram of a computer network over which transactions are made.

FIG. 2 is a schematic block diagram of a first embodiment of public key distribution system of the present invention.

FIG. 3 is a schematic block diagram of a first embodiment of public key verification system of the present invention.

FIG. 4 is a schematic block diagram of a second embodiment of public key distribution of the present invention.

FIG. 5 is a schematic block diagram of a second embodiment of public key verification system of the present invention.

### DETAILED DESCRIPTION OF THE PREFERRED EMBODIMENTS OF THE INVENTION

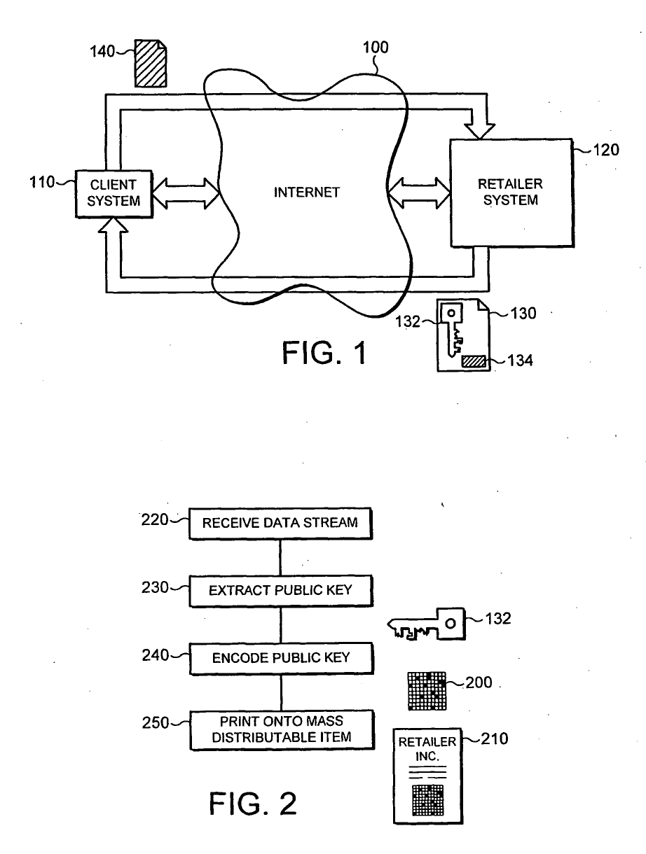

FIG. 1 shows a computer network 100 such as the Internet or other public network over which transactions are to be made. Internet 100 comprises a vast number of computers and computer networks that are connected through communications links, possibly including systems controlled by persons who may try to impersonate trustworthy parties.

A customer uses Internet web browser software running on a client system 110 such as a personal computer, personal digital assistant, radiotelephone supporting the wireless application protocol (WAP), or other electronic device with communications apparatus, to connect to a retailer's system 120 (such as an e-commerce website) in order to purchase products. The products can include items which are delivered electronically to the customer over the Internet (e.g. music or software) and items that are delivered through conventional distribution channels, such as by courier (e.g. books).

The client's web browser software supports a security protocol, such as the Secure Socket Layer (SSL) as developed by Netscape Communications, or the Private Communication Technology (PCT) as developed by Microsoft.

On connection to the secure server of the retailer site 120, typically effected by the customer clicking on a “pay” button after deciding on purchases, the server presents its public-key certificate 130 to the client system which contains the public key 132 and a digital signature 134 of a certificate authority (CA) that the customer trusts. A certificate authority is a commonly-trusted third-party, who is relied upon to verify the matching of public keys to identity information, issuance of credit, or other such information such as access privileges, and may in turn be certified by higher CA's. Typically, a web browser will ship with the public-key certificates of a number of CA's already installed. The browser will then ensure the public key received from the retailer's server is valid by decrypting the certificate with the public key of the CA. This portion of the transaction is part of a process referred to as an “SSL Handshake” and is used to accomplish a mutual authentication between client and server.

Sensitive data subsequently entered by the customer, such as the customer's name, order delivery details and credit card numbers, are encrypted by the web browser using the retailer's public key 132 before transmission over the network, and so the customer can then purchase with confidence.

The encrypted data 140 is sent over the network and received by the retailer's server, which then decrypts it using the retailer's private key (not shown) to recover the customer's sensitive data. The private key is kept secret and is never distributed. The customer's sensitive data may then be used by the retailer for processing of the payment and delivery details as is conventional. Typically, the retailer's server then confirms the order by sending a confirming web page or email message to the client computer system and schedules delivery of the items.

Thus, the customer can send sensitive data such as order details and credit card numbers over the public network in a secure and confidential manner.

Conventionally, the customer typically obtains the public key of the retailer directly from the retailer's site itself, or from another website, or from a public directory. A principal disadvantage associated with this method is that the customer receives a public key from a retail organisation electronically. In some cases, the customer will have had no prior relationship with the retail organisation. Thus, the customer may have difficulty trusting whether the given public key is genuine, or has somehow been substituted by some fraudulent party. One possible concern is that a customer may connect to a site believed to be that of a well-known retailer, when in fact the site has been intercepted by that of a fraudulent party. The customer may proceed to a transaction assuming the site to be genuine and receive a false public key on initiating a secure transaction. The fraudulent party can thus gain access to the sensitive customer data.

The existing approach to circumvent this problem has been to employ the use of Certification Authorities (CA's) as described above, namely trusted bodies set up for key distribution, which sign public keys of such retail and other organisations to guarantee their authenticity and distribute their own public keys widely so that they may be used to validate the public keys obtained from retailer sites. The CA's may, in turn, be certified by higher CA's. The economics of creating this infrastructure however constrain it from being deployed on a useful scale.

By obtaining the public key in a manner that is secure yet wholly external to the electronic transaction, a fraudulent party would have to circumvent this separate distribution mechanism to gain access to any sensitive data encrypted in this manner.

In the preferred embodiment of the invention, a retailer circulates its public key 132 in the physical form of a machine readable 2-D matrix symbology, or 2-D barcode, 200 containing encoded information. Barcode symbologies which may be used are, for example, Aztec, Data Matrix, QR Code, PDF417, Code One, ArrayTab and Vericode. Such an object is cheap to produce and may be incorporated in familiar mass-produced printed materials readily available to the customer such as company literature, national daily newspapers, Yellow Pages™ directories, receipts from retail premises, account statements, credit cards or other mass distribution means.

For example, a key plus signature data might require 350 bytes of data, which can satisfactorily be contained in a 2-D barcode which is 25 mm (1 inch) square.

FIG. 2 illustrates a typical process which can be performed by a computer system of a retailer operating in accordance with the invention, including the steps of:

220 receiving a data stream which contains a public key,

230 extracting the public key,

240 encoding the public key with a graphical code,

250 printing the graphical code onto a mass-distributable item 210.

Step 240 can contain several different steps. Firstly, the public key can be combined with some other useful data.

Secondly, the resulting data can advantageously be compressed, using a conventional data compression technique. Thirdly, the data can be signed, using a separately distributed key, for example the public key of a Certification Authority. Fourthly, it would be possible to encrypt the data if required. Finally, error correction codes can be added, using an appropriate conventional error correction encoding technique such as Reed-Solomon codes.

Steps 220 and 230 can effectively be omitted by being combined with the method used to generate the public key.

Additional steps can also be included in this process. For example, a fingerprint, or summary code, of the public key can be printed on the item 210 in human-readable form. Then, when the code is read by the user's computer system, software in that system can compute the fingerprint value, and ask the user to confirm that the computed value matches the value printed on the item. This provides a possible means of detecting substitution of the graphical code on an item.

As an alternative, or additionally, the graphical code can include a fingerprint of some larger body of material, for example, a full public key certificate. A public key certificate contains a public key, the identity of the party to whom it relates, information about the validity and intended use of the key, and the signature of each party (such as each Certification Authority in a “chain-of trust”) who verifies the correspondence between the key and the identified party.

This might be useful if the full certificate information is needed but is too large to fit in the graphical code (since some certificates can include several Kbytes of data when full chain-of-trust certificate information is included). Software in the user's computer system could retrieve the full chain-of-trust certificate information by other means, and use the fingerprint to verify it. For example, the material printed on the item 210 can include: a Uniform Resource Identifier (URI) for the full public key certificate value; and a fingerprint of that certificate. If a fraudster attempts to intercept or substitute the online certificate value, this would be detected by the user's computer system, by detecting the resulting mismatch with the fingerprint in the graphical code.

An advantage of implementing the invention in this way is that, even if a user does not have access to a scanner to read the graphical code, his computer system can obtain the public key certificate containing the required public key from the website identified by the URI, and can type in the human-readable fingerprint code, which the computer system can then check against a fingerprint code calculated from the public key obtained in that way.

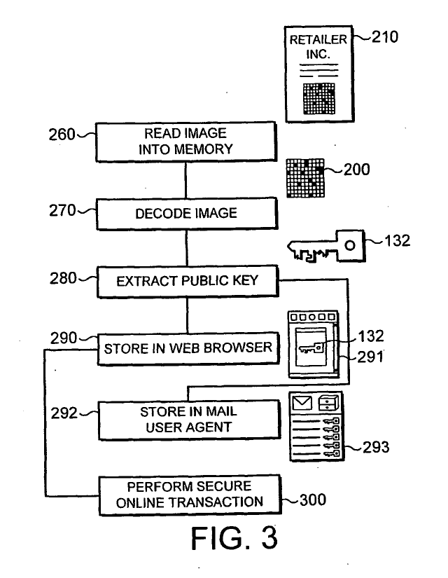

A customer obtains a copy of the public key 132 of the retailer, in the graphically encoded format, through one of the mass-distribution channels mentioned above. As shown in FIG. 3, the customer may then use software to decode the public key 132. Such software may be available as a plug-in to web browser software 291 to facilitate the process for the customer. For instance, such software may automate the steps of:

260 acquiring an image of the printed code using a handheld or flatbed scanner, and locating the code in the scanned image if necessary,

270 decoding the image,

280 extracting the public key, and

290 storing the public key in the customer's web browser's certificate manager.

Step 270 of decoding the image includes decoding the graphically encoded image to obtain the raw data, and mathematically decoding the data, which may for example include obtaining the data by removing the error correction coding.

Step 280 of extracting the public key includes checking any signature which was applied, for example using the public key of the signer. This public key may have been obtained by a conventional key distribution mechanism, or by a previous use of this process. Step 280 further includes decompressing the data if it was compressed. Finally, the public key can be obtained.

Before storing the public key, it is preferable to obtain confirmation from the user. For example, information associated with the key may allow the user to confirm that it is authentic.

Alternatively, or in addition, to step 290, the public key may be stored at step 292 in a mail user agent 293 to enable the customer to send encrypted email to the retailer system 120.

In a further alternative, the customer may not have access to image scanning facilities but may have access to a facsimile machine. A customer may transmit the encoded image by facsimile to an internet facsimile service together with his email address. The internet facsimile service may generate a representation of the facsimile, such as a bitmap image, and send it to the customer as a file attachment to an email message. The customer can then use software to decode the public key as described above. In an alternative, the internet facsimile service may perform the steps of decoding the public key as described above and email back the public-key certificate to the customer for use by the customer's web browser software.

Generally, this process can be repeated for each transaction which a user makes. However, having once obtained the public-key certificate of a retailer in this manner, on subsequent connection to a secure server provided by the same retailer, the need to request a copy of the public-key certificate is negated. The SSL handshake process could recognize that a public-key certificate for that retailer is already stored on the customer's machine.

Thus the customer can obtain a public key in a more secure manner than previously, and therefore can send sensitive data such as order details and credit card numbers over the network securely.

The security of using graphically encoded images containing public keys in hardcopy form lies both in their mass distribution and the media on which they are printed. If commonly printed in widely circulated brochures, directory listings, company literature, credit cards and the like, a fraudster would have to subvert all these possible channels in order to substitute a fake public key. Also, visibility of the key distribution mechanism means that detection of fraudulent substitutions is likely to happen more quickly.

Advantageously, the public key is graphically encoded using a 2-D matrix symbology, or 2-D barcode. The choice of symbology would take into consideration a number of factors, including: the physical area available for the symbol, the type of data to be encoded, the amount of data to be encoded, the type of printing equipment to be employed, and the robustness of the symbology. Because the symbol is provided in printed form, it may be conveniently transmitted by familiar means such as photocopying, faxing or other electronic or mechanical means whilst remaining robust and portable. Furthermore, the information may be quickly extracted using low cost scanning equipment and appropriate image processing and decryption software.

A 2-D matrix symbology is well suited for this purpose as it can encode a large amount of data in a given symbol size whilst maintaining a very high data security rate (the substitution error rate often can be better than 1 error in 1 million characters) and permitting near real-time data capture rates in comparison with other automatic methods of data entry.

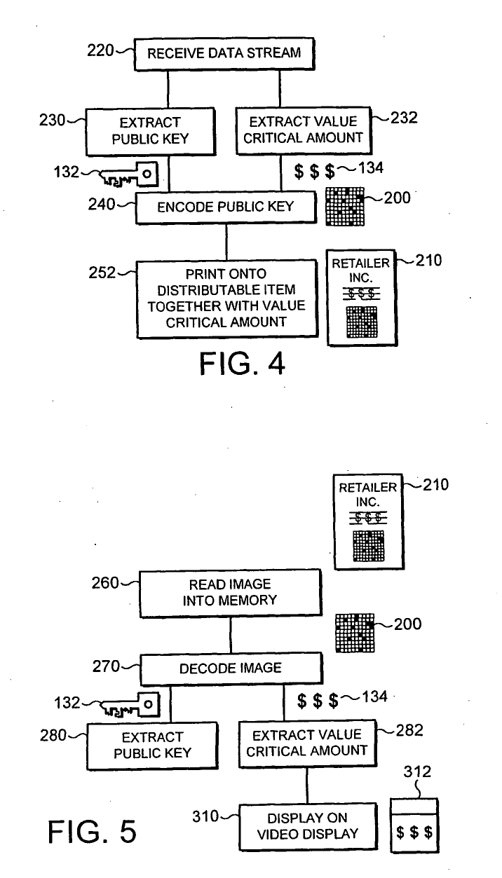

In a further embodiment of the invention, as illustrated in FIG. 4, a retailer issues a customer with a machine readable 2-D barcode 200 containing encoded information accompanied by a digital signature, the encoded information relating both to the public key 132 and to secondary transaction-specific data 134 which is known only to the user and the retailer. For instance, the barcode may be generated on performing a sales transaction and printed at the bottom of a sales receipt, and the secondary data may comprise the total value of the transaction also printed on the same receipt, as indicated by 252. The process illustrated in FIG. 4 is generally the same as that shown in FIG. 2, but is intended to be carried out at the same time as another transaction, for example a retail transaction at a retailer's premises. The process is further intended to be carried out in the customer's presence, under circumstances controlled by the supplier.

Thus, the printed encoded public key also encodes the secondary transaction-specific data, such as the sales value of the transaction. Alternatively, the secondary data may comprise an account number or password or other data known only to the retailer and customer. Thus, binding the public key information to some other information that is specific to a particular customer activity makes it more difficult to forge.

In this embodiment of the invention, the retailer or other service provider may print a 2-D barcode containing its own public key. However, organizations may usefully collaborate, such that the public key of an internet retailer may be obtained from a bank, for example.

In this instance, when the customer wishes to use the public key, for example in an online transaction with the retailer's website, the decryption software would decode the barcode image, as shown in FIG. 5, to produce both the public key 132 and extract (step 282) the secondary data 134. The secondary data would be displayed 310 on a video display 312 and the customer could then compare the secondary data already known with that extracted from the barcode as a further security check. If appropriate, the software could perform an automated comparison of the secondary data, such as the amount printed on the sales receipt, and a user-readable value if printed elsewhere on the image, and produce an output indicative of the correspondence.

There is thus described a method for distributing a public key in a secure manner. For example, the method described above can be used by a body such as a Certification Authority for the distribution of its public key. This would allow the public key to be changed at regular intervals, for example weekly or daily thereby reducing the possibility that a key will be compromised, and also reducing the liability in such an event.

It is to be noted that the field of the invention is not limited to on-line transactions over a network using a web browser equipped with SSL software, but may be used with any secure transaction method involving public-key certification, such as Private Communications Technology (PCT) or Cybercash.

Furthermore, the method of the invention has been described with reference to a transaction in which one party has a mass-distributable public key. However, it will be apparent to one of skill in the art that the method applies equally to transactions in which both parties have distributed their public keys in this way. For instance, such a situation may occur particularly between corporate bodies such as a retailer and a wholesaler conducting an online transaction.

It is to be noted that the use of mass-distribution of digital data in printed form as described is not limited to the field of e-commerce but may find applications in other areas in which any sensitive electronic data such as documents are to be distributed in a secure manner. In particular, public-key encryption is a popular tool for ensuring security in mail messages, transmitted files such as electronic documents, and protecting locally stored data on a network.

1. A method for distributing a public key, comprising:
a) receiving a data stream containing a public key;
b) extracting said public key from said data stream;
c) encoding said public key in accordance with a predetermined graphical code;
d) printing said encoded public key onto a mass produced item in machine readable form.

2. A method as claimed in claim 1, comprising printing the encoded public key in optically readable form.

3. A method as claimed in claim 2, in which said machine readable form used is a 2-D barcode symbology.

4. A method as claimed in any preceding claim, in which said step of printing the encoded public key further comprises printing a human readable fingerprint of the public key.

5. A method as claimed in any preceding claim, in which said step of encoding the public key comprises compressing the data.

6. A method as claimed in any preceding claim, in which said step of encoding the public key comprises signing the data with a separately distributed second key.

7. A method as claimed in any preceding claim, in which said step of encoding the public key comprises applying error correction coding thereto.

8. A method for distributing a public key as claimed in any preceding claim, in which said mass produced item is substantially made from paper or other printable material.

9. A method for distributing a public key as claimed in claim 8, in which said mass produced item is a cheque, purchase receipt, newspaper or magazine.

10. A method as claimed in any preceding claim, in which said step of encoding the public key comprises combining the public key with a fingerprint of a corresponding public key certificate.

11. A method for obtaining a mass-distributed public key comprising the steps of:
a) reading an image of an encoded data item from a mass produced item into a memory, said data item comprising a public key;
b) decoding said encoded data item into a user-readable public key, in accordance with a predetermined code;
c) extracting said public key.

12. A method as claimed in claim 11, in which said encoded data item is a compressed public key which has been encoded in accordance with a 2-D barcode symbology.

13. A method as claimed in claim 11 or 12, further comprising the step of storing said extracted public key in electronic mail user agent (MUA) software.

14. A method as claimed in any one of claims 11 to 13, further comprising the step of storing said extracted public key in a web browser facility.

15. A method as claimed in any one of claims 11 to 14, further comprising the step of using said extracted public key in a secure transaction.

16. A method as claimed in claim 15, in which said transaction takes place on-line over a public network using a secure server.

17. A method as claimed in claim 11, further comprising the step of computing a fingerprint of the extracted public key, and displaying the extracted public key to a user.

18. A method as claimed in claim 11, further comprising the steps of extracting a fingerprint of a public key certificate corresponding to the extracted public key from the encoded data; obtaining the public key certificate from an alternative source; computing a fingerprint of the public key certificate; and comparing the extracted fingerprint and the computed fingerprint.

19. A method for supplying a public key from a distributor to a recipient, the method comprising:
a) receiving a data stream from a computer, the data stream containing the public key;
b) receiving transaction-specific data known to the distributor and receiver;
c) extracting said public key from said data stream;
d) encoding said public key and said transaction-specific data in accordance with a predetermined graphical code;
e) printing said encoded data in machine readable form; and
f) supplying the printed item to the receiver.

20. A method as claimed in claim 19, comprising printing the encoded data in optically readable form.

21. A method as claimed in claim 20, in which said machine readable form used is a 2-D barcode symbology.

22. A method as claimed in one of claims 19 to 21, in which the transaction-specific data comprises a value of a transaction.

23. A method for enabling verification of a public key, the method comprising:
(a) reading an image of an encoded data item from a printed item into a memory, said data item comprising a public key and a transaction-specific amount known to the distributer and receiver;
(b) decoding said encoded data item into the public key and the transaction-specific amount, in accordance with a predetermined code; and
(c) extracting said public key.

24. A method as claimed in claim 23, further comprising the step of storing said extracted public key in web browser software.

25. A method as claimed in claim 23 or 24, further comprising the step of storing said extracted public key in electronic mail agent software.

26. A method as claimed in any one of claims 23 to 25, comprising displaying the transaction-specific data in user-readable form on a video display.

27. A software product which contains code for implementing a method according to any of the preceding claims.

28. A software product as claimed in claim 27, further containing code for interfacing with Internet web browser software.

29. A software product as claimed in claims 27 or 28, in which the method is activated automatically on connection to a trader's secure server facility.

30. A computer system, comprising a software product as claimed in any of claims 27 to 29.
